(19) United States
(12) Patent Application Publication
(10) Pub. No.: US 2022/0305692 A1
(43) Pub. Date: Sep. 29, 2022

(54) A SEMI-WET MILLING STRATEGY TO FABRICATE ULTRA-SMALL NANO-CLAY

(71) Applicant: THE UNIVERSITY OF QUEENSLAND, St Lucia, Queensland (AU)

(72) Inventors: Jun ZHANG, St Lucia, Queensland (AU); Chengzhong YU, Sinnamon Park, Queensland (AU); Yue WANG, St Lucia, Queensland (AU)

(21) Appl. No.: 17/616,885

(22) PCT Filed: Jun. 5, 2019
(86) PCT No.: PCT/AU2019/050575

§ 371 Date: Dec. 6, 2021

(51) Int. Cl. B28C 3/00; B28C 1/06; C01B 33/40; C09C 1/42

(52) U.S. Cl. CPC B28C 3/00; B28C 1/06; C01B 33/40; C09C 1/42; C01P 2004/03; C01P 2002/72

(57) ABSTRACT

A method for producing nano-clays comprising forming a mixture of a clay and water, wherein water is present in an amount of from 2 to 10% by weight of the total weight of clay and water, and milling the mixture of clay and water in the presence of a grinding media to form the nano-clay.

### TECHNICAL FIELD

The present invention relates to a milling process to form nano-clays.

### BACKGROUND ART

Clays are composed of phyllosilicate minerals. Clays are typically layered structures composed of Si-tetrahedrons and Al-octahedrons. Clays are classified into three or four main groups, being kaolinite, montmorillonite-smectite, illite and chlorite. Clays are capable of exchanging cations and capable of adsorbing liquids or gases.

Vermiculite is a hydrous phyllosilicate material. It undergoes significant expansion when heated. It has a high cation exchange capacity and can have low density following heating. Vermiculite is widely available and relatively inexpensive. Vermiculite can be described as a 2:1 clay, meaning it has two tetrahedral sheets for every one octahedral sheet. Vermiculite clays are able to exchange ions that are located between the molecular sheets.

There are a number of applications of clay materials that take advantage of the cation exchange capacity of the clays. These include use of the clays as soil ameliorants in which the clays with exchangeable ions are mixed into soil so that exchangeable nutrient or trace mineral ions can be transferred into the soil. Similarly, clays with nutrient ions can be added to animal feedstocks as mineral supplements. Other applications of clays utilise their ability to adsorb other materials, such as oils. Clays can be used as a vehicle for carrying these other components. If the other components are volatile, the clays can also significantly reduce the loss of those materials due to volatilisation.

It will be clearly understood that, if a prior art publication is referred to herein, this reference does not constitute an admission that the publication forms part of the common general knowledge in the art in Australia or in any other country.

### SUMMARY OF INVENTION

The present invention is directed to a milling process for forming nano-clays. The nano-clays may comprise nano-vermiculite, nano-bentonite, or any other claim material that has been reduced in size. Throughout this specification, the term “nano-clays” will be used to refer to clay materials that have a particle size that is predominantly less than 1 μm. For example, the nano-clay may have at least 50% of its particles, by weight, being sized less than 1 μm, or at least 60% of its particles, by weight, being sized less than 1 μm, or at least 70% of its particles, by weight, being sized less than 1 μm, or at least 80% of its particles, by weight, being sized less than 1 μm, or at least 90% of its particles, by weight, being sized less than 1 μm, or at least 95% of its particles, by weight, being sized less than 1 μm, or substantially all of its of its particles being sized less than 1 μm.

In some embodiments, nano-clay with ultra-small size of <100 nm can also been achieved in the present invention. For example, the nano-clay may have at least 50% of its particles, by weight, being sized less than 100 nm, or at least 60% of its particles, by weight, being sized less than 100 nm, or at least 70% of its particles, by weight, being sized less than 100 nm, or at least 80% of its particles, by weight, being sized less than 100 nm, or at least 90% of its particles, by weight, being sized less than 100 nm, or at least 95% of its particles, by weight, being sized less than 100 nm, or substantially all of its of its particles being sized less than 100 nm.

In a first aspect, the present invention provides a method for producing nano-clays, the method comprising forming a mixture of a clay and water, wherein water is present in an amount of from 2 to 10% by weight of the total weight of clay and water, and milling the mixture of clay and water in the presence of a grinding media to form the nano-clay.

In one embodiment, the grinding media may comprise a plurality of balls. The grinding media may comprise agate balls. The grinding media may comprise ceramic balls. The grinding media may comprise metal balls.

In other embodiments, the grinding media may comprise rods. Other shaped grinding media may also be used.

The milling step will be typically conducted in a mill. The mill is caused to rotate, which causes the mixture of clay, water and grinding media to also rotate. The mixture of clay, water and grinding media will be raised upwardly as the mill is rotated and the mixture will, at some stage during the rotation, fall downwardly under the influence of gravity. This causes collisions between the grinding media and the clay, which reduces the size of the clay particles.

In another embodiment, a planetary ball mill may be used. For example, a planetary ball mill may consist of 2-4 grinding jar arranged eccentrically on a base wheel. The base wheel rotates oppositely to that of the grinding jars making grinding balls in the jars with superimposed rotational movements (Coriolis forces). The frictional and impact forces between balls and jars release high dynamic energies, resulting in high and very effective degree of size reduction of the planetary ball mill.

Any suitable mill may be used. The skilled person will readily understand the types and nature of suitable mills that can be used in the method of the present invention. The mill is suitably a ball mill.

In one embodiment, the mixture of clay and water comprises from 5% to 10% water, calculated as a weight percentage of the weight of water of the total weight of the clay and water. In other embodiments, the mixture of clay and water comprises from 6% to 10% water, or from 7% to 10% water, from 8% to 10% water, or from 9% to 10% water, all calculated as a percentage of the weight of water of the total weight of the clay and water.

The milling step may be conducted for a period of from 5 minutes to 5 hours, or from 10 minutes to 4 hours, or from 30 minutes to 2 hours, or for a period of up to 2 hours. The present inventor has found that although the milling step can be conducted for periods in excess of 2 hours, significant further reductions in particle size are not obtained when the milling time has exceeded 2 hours. Therefore, the present inventor believes that practical embodiments of the present invention will utilise a milling time of up to 2 hours.

The present inventors have found that the milling process in accordance with the present invention can produce nano-clays by using the water content as specified above. Prior art milling processes to produce nano-clays required water contents of greater than 12% in the milling step, and this typically led to the formation of a sticky paste that was difficult to separate from the grinding media. Indeed, it was often necessary to subject the mixture of ground material with the grinding media to drying in order to separate the grinding media from the ground material. Drying in the prior art is potentially a slow or expensive step, due to the requirement to remove reasonably large amounts of water. In contrast, in the present invention, separation of the grinding media from the ground material is relatively straightforward. If drying is required, the lower amounts of water present mean that the drying step is quicker and/or less expensive.

The present inventors have also surprisingly found that the milling process in accordance with the present invention can produce nano-clays with ultra-small sizes of <100 nm by using the water content as specified above as well as the addition of further materials. The further materials may be in the form of particulate material. The further material suitably includes metal ions that assist in exfoliating the clay layers and/or breaking Si—O/Al—O framework of the clay to break the clay particles into thin and small particles. In some embodiments, the further material may be selected from a salt, a metal oxide, biochar, or mixtures of two or more thereof. The further material is suitably in particulate form to efficiently exfoliate and break the clay particles.

The further particulate material may be added in an amount of from 5% to 15%, by weight, calculated as a weight percentage of the weight of water and clay. The present inventors have found that adding more than 15% by weight of the further particulate material has a diminishing effect on the grinding of the clay.

Without wishing to be bound by theory, the present inventors have postulated that adding the further particulate material that includes free metal ions that can assist in breaking Al—O bonds causes both a physical grinding effect in the milling step and a chemical effect, which can assist in forming ground particles of nano-clay that have reduced thickness when compared to the particles of nano-clay that are obtained without the further particulate material being present in the milling step. Indeed, the present inventors have discovered that the nano-clay particles formed in this embodiment of the invention are in the form of much thinner plates, such as platelets that have only two layers of the molecular structure of the clay. In some embodiments, the particles of nano-clay in this embodiment have a thickness of about 4 nm.

In one embodiment, the further material comprises a salt. The salt may be selected from magnesium chloride, magnesium sulphate, magnesium nitrate, sodium chloride, sodium sulphate, sodium nitrate, potassium chloride, potassium sulphate, potassium nitrate, calcium chloride, calcium sulphate, calcium nitrate, iron chloride, iron sulphate, iron nitrate, zinc chloride, zinc sulphate and zinc nitrate. This list should not be considered to be limiting. The salt is suitably in the form of particulate material.

In one embodiment, the further material comprises a metal oxide. The metal oxide may be selected from magnesium oxide, iron oxide, magnetite, calcium oxide. This list should not be considered to be limiting and other metal oxides may be used. The metal oxides are suitably in the form of particulate material.

In a further embodiment, the further material comprises biochar. Biochar may be obtained by calcining or charring biomaterial, such as crop stalks, wood, or other cellulosic materials, or from fruit or vegetable materials, such as waste fruit or waste vegetables. The biochar may be sourced from corn, bagasse, straw, miscanthus, switchgrass, hemp, corn, poplar, willow, sorghum, sugarcane, bamboo. The biochar is suitably in the form of particulate material.

In some embodiments, the clay comprises vermiculite. In other embodiments, the clay comprises bentonite, beidellite, ripidolite, Na⁺-montmorillonite, organo-montmorillonite clays, kaolin and kaolinite. Mixtures of two or more clays may be used.

The grinding media may comprise any suitable grinding media known to the person skilled in the art. Ideally, the grinding media will not contaminate the ground product material. The grinding material, in some embodiments, comprises grinding balls. The grinding balls may comprise agate balls or ceramic balls. The grinding balls may be of any suitable size, such as 5 mm diameter or 10 mm diameter. Investigations conducted by the present inventors indicate that the size of the grinding balls is not especially critical.

In one embodiment, the nano-clay obtained by the method of the present invention has a narrow particle size distribution. In some embodiments, the particle size varies by no more than + or −20% from the median particle size.

The nano-clay formed in the process of the present invention has small particle size and enhanced ability to take up other materials, such as nutrients or beneficial agents. The nutrients or beneficial agents may comprise ionic material, cationic material, trace metals, essential oils, anti-bacterial oils, antifungal compounds, agricultural additives, nutritional supplements, nitrification inhibitors, or the like.

In a further embodiment of the present invention, the method further comprises the step of separating ground material from the grinding media.

In another embodiment of the present invention, the method further comprises the step of separating ground material from the grinding media and mixing the nano-clay with one or more agents such that the one or more agents are taken up by the nano clay.

In one embodiment, the one or more agents is antimicrobial essential oil (oregano oil, tea tree oil), nitrification inhibitor (dicyanamide (DCD) and 3,4-dimethylpyrazol phosphate).

In one embodiment, the further particulate material added to the milling step is partially taken up by the nano-clay, or part of the further particulate material is taken up by the clay.

In one embodiment, the clay that is fed to the milling step comprises vermiculite. The vermiculite may comprise expanded vermiculite.

In one embodiment, the clay that is supplied to the milling step is pre-treated. The pre-treatment may comprise contacting the clay with a dilute acid, followed by washing with water. In one embodiment, the clay is dried following washing. In one embodiment, the purpose of the pre-treatment step is to remove possible paragenetic minerals including carbonates. If raw clay of high purity is used in the fabrication of nano-clay, the pre-treatment step can be avoided.

In another aspect, the present invention provides a method for producing nano-clays, the method comprising forming a mixture of a clay and water, wherein water is present in an amount of from 2 to 10% by weight of the total weight of clay and water, and milling the mixture of clay and water in the presence of further material including metal ions that assist in exfoliating the clay layers and/or breaking Si—O/Al—O framework of the clay to break the clay particles into thin and small particles to form the nano-clay. The further material may be as described with reference to the first aspect of the present invention.

The process of the present invention provides a simple and efficient method for preparing nano-clay having an enhanced ion exchange capacity or enhanced adsorption capacity. The method is a semi-wet milling method that uses lower water levels than known wet milling steps used to produce nano clay. All previous wet milling methods known to the applicant used a minimum of 12% by weight water content in the milling step, which resulted in a sticky paste that caused difficulties in separating the grinding media from the resulting ground material.

In embodiments of the present invention where further material or further particulate material is added, even smaller particle sizes in the nano-clay can be obtained, with the nano-clay including platelets having a very small number of layers and accordingly a very small thickness. This results in a large specific surface area and enhanced ion exchange capacity or enhanced adsorption capacity. Investigations have revealed that the nano-clay made by the present invention is especially suitable for taking up other agents.

The skilled person will recognise that a number of different milling parameters can be controlled during the milling process. For example, the speed of the mill, the power input to the mill, the loading of clay material in the mill, the ratio of liquid to solids in the mill, the loading of grinding media in the mill, and the diameter of the mill can all be controlled or selected to desired levels. The skilled person will also recognise that these operating parameters may be selected or controlled by the skilled person in accordance with the volume throughput desired to be obtained, the particle size of the product particles and the milling time. The present inventors have conducted laboratory scale testing to date and the relevant parameters used in that testing are set out in the examples of this specification.

Any of the features described herein can be combined in any combination with any one or more of the other features described herein within the scope of the invention.

The reference to any prior art in this specification is not, and should not be taken as an acknowledgement or any form of suggestion that the prior art forms part of the common general knowledge.

### BRIEF DESCRIPTION OF DRAWINGS

Various embodiments of the invention will be described with reference to the following drawings, in which:

FIG. 1 shows (A) Schematic image of the semi-wet milling process to synthesize clay nanoparticles and their potential applications: (B) high cation exchange capacity of the clay nanoparticles for soil amendment, loading of agricultural actives for (C) reduced nitrification and (D) bacterial inhibition;

FIG. 2 shows (A) Digital photo of raw vermiculite, (B) FE-SEM images of pre-milled vermiculite;

FIG. 3 shows FE-SEM images in (A) high and (B) low magnification, (C) TEM image and (D) EDS elemental mapping of NanoV-W5;

FIG. 4 shows FE-SEM images of a series of nanovermiculite (A, B) NanoV-W5FeO10, (C, D) NanoV-W5MgO10 and (E, F) NanoV-W5B10 in different magnifications;

FIG. 5 WA-XRD patterns of a series of nanovermiculites and corresponding additives;

FIG. 6 (A) Digital photo, (B) TEM image, (C) STEM elemental mapping and (D, E) AFM images from the top and side view of NanoV-W5MgCl10;

FIG. 7 shows FE-SEM images of (A, B) NanoV-W5MgCl5, (C, D) NanoV-W5MgCl10 and (E, F) NanoV-W5MgCl15 in different magnifications;

FIG. 8 shows DLS results of nanovermiculite samples with (A) the increasing amount of the MgCl₂ additives, or (B) the increasing amount of water in the ball milling process;

FIG. 9 shows (A) Digital photo of nanovermiculite milled with 15% water and 10% of MgCl₂ after ball milling, (B) TEM image of NanoV-W5MgSO10, (C) digital photo and (D) TEM image of NanoB-W5MgCl10;

FIG. 10 shows (A) WA-XRD patterns of NanoV-W5MgCl10 and NanoV-W5MgSO10, (B) SA-XRD patterns of a series of samples including NanoV-W5, NanoV-W5MgO10, NanoV-W5 Cl10 and NanoV-W5MgSO10;

FIG. 11 shows XPS results of (A) raw vermiculite and (B) NanoV-W5MgCl10;

FIG. 12 shows DCD loading amount;

FIG. 13 shows (A) TGA and (B) isothermal release behaviour of free OEO and OEO loaded NanoV-W5; and

FIG. 14 shows CFU assay results comparing the long term inhibition efficiency of nanovermiculite, raw vermiculite and free OEO formulations.

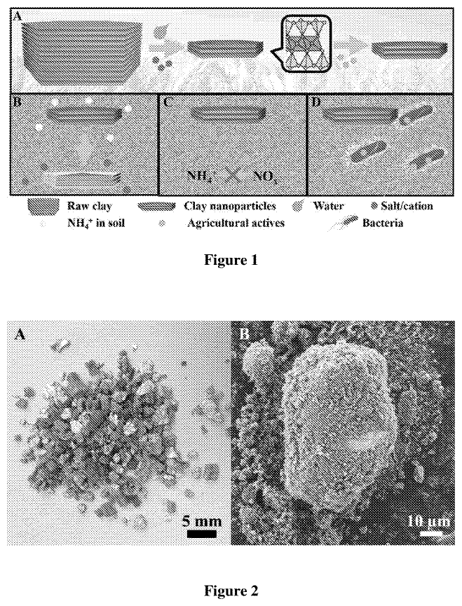

### EXAMPLES

A series of experiments were conducted, as follows:

Chemicals

The grade 3 vermiculite and bentonite used in the present study is from Queensland, Australia. Fe₂O₃ and MgO were synthesized according to the procedures developed by Yu Group (S. Purwajanti, L. Zhou, Y. A. Nor, J. Zhang, H. W. Zhang, X. D. Huang, C. Z. Yu, ACS Appl. Mater. Interfaces 2015, 7, 21278-21286; and L. Zhou, H. Y. Xu, H. W. Zhang, J. Yang, S. B. Hartono, K. Qian, J. Zou, C. Z. Yu, Chem. Commun. 2013, 49, 8695-8697). Biochar was prepared from corn residue according to the method reported by Nguyen et al (B. T. Nguyen, J. Lehmann, Org. Geochem. 2009, 40, 846-853). Ammonium acetate (NH₄Ac) and dicyandiamide (DCD) was purchased from Sigma-Aldrich. MgCl₂ and MgSO₄ were purchased from Chem-Supply Pty Ltd. Pure water (Millipore 18-mΩ/cm water solution) was provided from the University of Queensland chemical store and was used to prepare all solutions/dispersions. All the other reagents were of analytical reagent grade.

In the examples, a planetary ball mill was used. The planetary ball mill consisted of 2-4 grinding jars arranged eccentrically on a base wheel. The base wheel rotates oppositely to that of the grinding jars making grinding balls in the jars with superimposed rotational movements (Coriolis forces). The frictional and impact forces between balls and jars release high dynamic energies, resulting in high and very effective degree of size reduction of the planetary ball mill.

The power input of the planetary ball mill was 1730 W (230 V). The ratio of the internal volume of mill jars to the power of the mill is 1000 ml (4×250 ml in planetary mill):1730 W. In one embodiment, the loading of grinding media compared to the amount of clay and water (and salt if present) in volume is 1:4. In other embodiments, the loading of grinding media compared to the amount of clay and water (and salt if present) in volume can be tuned to be 1:4-1:1.22. In one embodiment, the mill rotates at the speed of 300 rpm. The diameter of the mill is 24 cm.

Pre-Treatment of Vermiculite/Bentonite

In the pre-treatment of vermiculite or bentonite, HCl solution was used to dissolve the carbonates. ˜100 g of vermiculite or bentonite was weighted and soaked in 2 L of 10⁻⁴ M HCl solution for 5 min. The vermiculite or bentonite was then filtered, washed three times by deionized water and dried in a 50° C. oven overnight. The samples with pre-treatment were denoted as raw vermiculite and raw bentonite. As the raw vermiculite is expanded, it density is very low. Before the semi-wet milling process, the raw vermiculite chucks were milled into vermiculite powder with a higher density in a Fritsch® Planetary Mill PULVERISETTE 5 classic line with 250 ml agate grinding bowl and 5-10 mm agate balls. In this pre-milling step, 10 g of raw vermiculite was placed in the agate bowl with the balls, and the mixture was milled at the speed of 300 rpm for 0.5-1 hour. The product is denoted as pre-milled vermiculite.

Ball Milling of Vermiculite Nanoparticles

In a semi-wet milling procedure, 90 g of pre-milled vermiculite, 5-15 g (5-15%) of water and/or 10 g of additive (Fe₂O₃, MgO, biochar, MgCl₂ or MgSO₄) were placed in the agate bowl with 5-10 mm agate balls and milled at 300 rpm for at least 2 hours.

In another series of experiments, 90 g of raw bentonite, 5 g (5%) of water and 10 g (10%) of MgCl₂ were milled in the same condition for 2 hours. The ingredients for all the samples and their denoted names are listed in Table 1. All samples after semi-wet milling were placed in an oven at 50° C. until dry.

TABLE 1
Sample names and additives in the milling process.

| Sample | Nano | Nano-V- | NanoV- | NanoV- | NanoV- | NanoV- |
|---|---|---|---|---|---|---|
| Name | V-W5 | W5B10 | W5FeO10 | W5MgO10 | W5MgCl5 | W5MgCl10 |
| Ingredients | Vermiculite | Vermiculite | Vermiculite | Vermiculite | Vermiculite | Vermiculite |
| | 5% water | 5% water | 5% water | 5% water | 5% water | 5% water |
| | | 10% biochar | 10% Fe₂O₃ | 10% MgO | 5% MgCl₂ | 10% MgCl₂ |

| Sample | NanoV- | NanoV- | NanoV- | NanoV- | NanoB- |
|---|---|---|---|---|---|
| Name | W5MgCl15 | W10MgCl10 | W15MgCl10 | W5MgSO10 | W5MgCl10 |
| Ingredient | Vermiculite | Vermiculite | Vermiculite | Vermiculite | Bentonite |
| | 5% water | 10% water | 15% water | 5% water | 5% water |
| | 15% MgCl₂ | 10% MgCl₂ | 10% MgCl₂ | 10% MgSO₄ | 10% MgCl₂ |

Characterizations

The morphologies of the clay samples after ball milling were observed using and JEOL JSM 7800 field emission scanning electron microscope (FE-SEM) operated at 5 kV. For FE-SEM measurements, the samples were prepared by dispersing the powder samples in water, after which they were dropped to the aluminum foil pieces and attached to conductive carbon film on SEM mounts. The transmission electron microscopy (TEM) images were obtained using a JEOL 2100 microscope operated at 100 kV. The TEM specimens were prepared by dispersion of the samples in ethanol after ultrasonication for 5 min, and then deposited directly onto a carbon film supported copper grid. Energy-dispersive X-ray spectroscopy (EDS) elemental mappings were conducted in the high angle annular dark field (HAADF) scanning transmission electron microscopy (STEM) mode. Wide angle and small angle X-ray diffraction (WA-XRD, SA-XRD) patterns of the materials were recorded on a Rigaku X-ray powder diffractometer with Co Kα Radiation. The hydrodynamic size of the nanovermiculite particles was measured in aqueous solution using a Zetasizer Nano-ZS. The atomic force microscopy (AFM) analysis of vermiculite after semi-wet ball milling was conducted by a Cypher S atomic force microscope (Oxford Instrument) in tapping mode in the air. The AFM samples were prepared by depositing the vermiculite-water dispersion onto the freshly cleaved mica surface.

Cation Exchange Capacity (CEC) Test

The CEC values of all samples were measured by displacing exchangeable cations using ammonium ions. In a typical procedure, ˜30 mg of airdried sample was dispersed in ˜15 mL of a 1 mol/L ammonium acetate solution. The pH value of the dispersion during the exchange process was kept at ˜7 by the addition of small volumes of a 10⁻⁴ M HCl or NH₃ solution. The dispersions were shaken in a incubator at 200 rpm and at room temperature for 3 days. The dispersions were then centrifuged in high speed (20000 rpm) to separate the solid and the liquid. The supernatants were filter. The ions exchanged by ammonium ion were analyzed by inductively coupled plasma-optical emission spectrophotometry (ICP-OES) PerkinElmer Optima 7300DV. The CEC values are expressed in meq/kg were calculated according to Equation 1.

$$CEC = \sum \frac{CmVN}{Mw} \qquad Equation 1$$

where Cm: cation concentration in the supernatant tested by ICP-OES; V: volume of the supernatant (15 ml); N: charge number of exchanged cation; Mw: weight of dry nano-clay sample for the CEC test.

DCD Adsorption Study

DCD-ethanol stock solution was prepared by dissolving 5 mg of DCD in 5 ml of ethanol (1 mg/ml). To 1 ml of DCD-ethanol solution, 1 mg of raw vermiculite, NanoV-W5MC110, raw bentonite or NanoB-W5MC110 was added. The mixture was shaked at 200 rpm at room temperature in the dark for 3 hours and then centrufugated. The adsorption amount of DCD by the materials was evaluated by measuring the centration of DCD in the supenatant at 215 nm using UV-Vis spectrometer.

OEO Loading and Isothermal Release

OEO was loaded with NanoV-W5 and raw vermiculite by mechanical mixing with the OEO:carrier ratio of 1:95. Thermogravimetric analysis (TGA) was conducted using a TGA/DSC 1 Thermogravimetric Analyzer (Mettler-Toledo Inc) to determine the amount of OEO loaded in the formulations and to quantify isothermal release behavior of the OEO from the carrier.

In a typical procedure, ˜10-15 mg of NanoV-W5 (with and without OEO) or free OEO was placed in an aluminium pan and heated from 25° C. to 900° C. at a heating rate of 2° C./min at an air flow rate of 20 mL/min. Isothermal TGA testing was conducted using the same equipment as above. ˜10-15 mg of NanoV-W5 (with and without OEO) or free OEO was placed into an aluminium pan and heated from 25° C. to 60° C. at a heating rate of 2° C./min at an air flow rate of 20 mL/min and then the temperature was kept at 60° C. for 14 h.

Long Term Bacterial Inhibition Test

Long term bacterial inhibition provided by free OEO and OEO-loaded nano-clay was assessed by CFU assay at an oil concentration of 0.88 mg/mL as a function of time. Typically, bacterial suspension (100 μL of 3.5×107 CFU/mL) was added into the LB medium (800 μL) for each 1.5 mL centrifuge tube. Then 100 μL of the samples diluted in PBS was added and shaken at 37° C. on a shaker bed at 200 rpm. Several tubes of samples are prepared for corresponding time points. At selected time points (4 h, 12 h, 24 h, 48 h and 72 h), the bacterial viability was recorded by CFU. One control group with only bacteria was used.

Results and Discussion

Vermiculite is a hydrous phyllosilicate mineral with layered structures composed of Si-tetrahedrons and Al-octahedrons.^{[4]} The CEC value of vermiculite is very high among clay materials (1000-1500 meq/kg) and the price of vermiculite is usually very cheap. Raw vermiculite after the removal of the carbonates is in 1-5 mm pieces with golden colour and low density (FIG. 2A). After a pre-milling process in dry conditions, the pre-milled vermiculite is still in large chunks with the size of >50 μm (FIG. 2B).

A facile and scalable synthetic procedure of vermiculite nanoparticles have been developed using ball milling, after which all samples are in the form of fine powders. In one batch, ˜300 g of finely milled vermiculite can be synthesized, which is determined by the volume of the ball milling bowls.

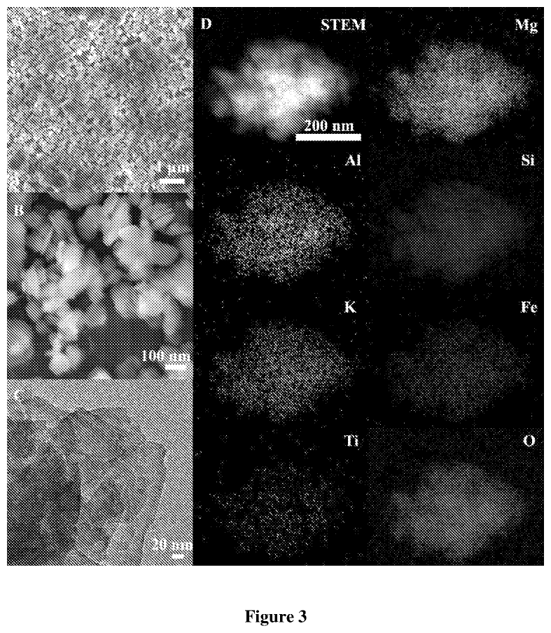

The morphology and elemental content of NanoV-W5 can be directly observed using electron microscopy (FIG. 3). FIG. 3A shows that with the addition of 5% water in the ball milling process, the size of NanoV-W5 decrease into a range of 0.2-1 μm._{[JZ1]} Although very small size particle (˜150 nm) can be observed in high resolution FE-SEM (FIG. 3B), the size distribution is still in a very broad range. The TEM image of NanoV-W5 shows plate-like particle with 4-6 layers (FIG. 3C). It is revealed that by adding small amount of water, vermiculite can be milled into fine powders with sub-micron sized clay nanoparticles._{[JZ2]}

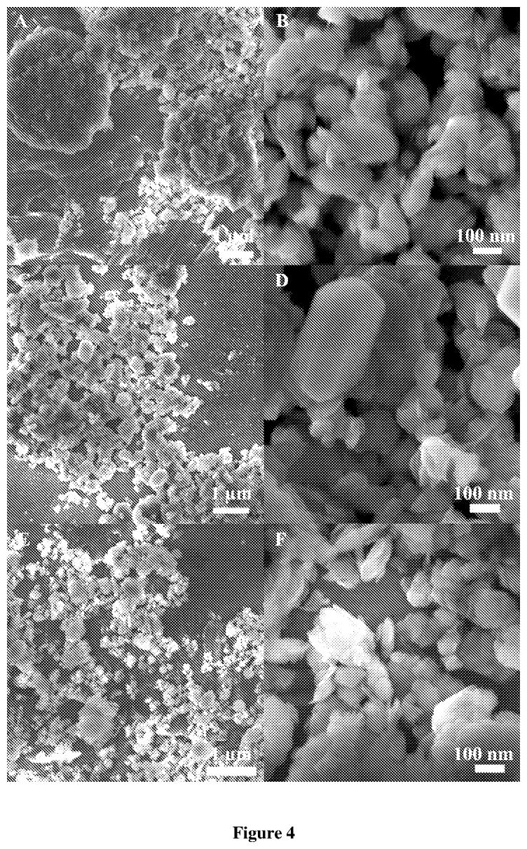

A series of additives were also added in the ball milling process of vermiculite with the existence of 5% of water, including Fe₂O₃, MgO and biochar. Some of the further particulate media do not need to be in particulate form (for example biochar). The FE-SEM image of NanoV-W5FeO10, NanoV-W5MgO10 and NanoV-W5B10 shows that all samples show sub-micron sized vermiculite nanoparticles with the size of 150-500 nm (FIG. 4). The FE-SEM image of NanoV-W5FeO10 in low magnification shows few Fe₂O₃ spheres with the size of ˜1 μm (FIG. 4A). Nevertheless, nanovermiculite in plate-like structure with the size of 150-500 nm can be observed (FIG. 4B). In comparison, MgO added in NanoV-W5MgO10 has been milled into sub-micron sized nanocrystals (Figure D). Nanovermiculite in plate-like structure with the size of 150-500 nm can also be observed in NanoV-W5MgO10 and NanoV-W5B10 (FIG. 4C-F). It is reveal that the addition of metal oxides and biochar can further decrease the size of vermiculite with the existence of 5% of water.

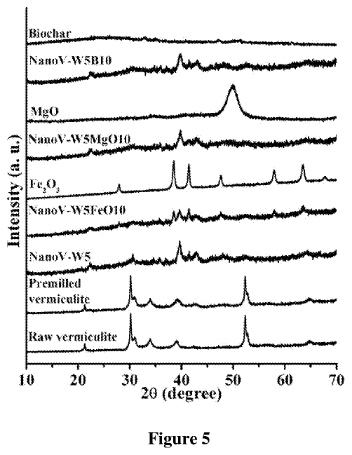

The crystalline states of the above samples are characterized by WA-XRD (FIG. 5). The WA-XRD patterns of raw and pre-milled vermiculite show a series of sharp peaks at 21, 30, 31, 34, 39 and 52° which are the characteristic peaks of 02 [symbol] 11 [symbol] 20 [symbol] 13 [symbol] 06 [symbol] and 33 [symbol] diffractions of crystalline vermiculite.^{[5]} The narrow widths of these peaks are in accordance with the large particle size of the vermiculite crystals. The WA-XRD pattern of NanoV-W5 shows significantly broadened characteristic peaks with much lower intensity, indicating a decreased particle size. In the WA-XRD pattern of NanoV-W5FeO10, further broadened characteristic peaks of the vermiculite and Fe₂O₃ can be observed. The characteristic peaks at 28, 38.5, 41.5, 47.7, 58 and 63.5° are attributed to Fe₂O₃ and the broadened peak widths indicate the size reduction of Fe₂O₃. Even more broadened characteristic peaks of vermiculite can be observed in the WA-XRD pattern of NanoV-W5MgO10 and NanoV-W5B10. Utilizing the peak width, the particle sizes of both nanovermiculites are calculated to be ˜111 nm from Debye-Scherrer Equation. Besides, NanoV-W5MgO10 shows no characteristic peak of MgO (50°). This phenomenon indicates the majority of MgO additive has been milled into near amorphous state with very small particle size. Due to the amorphous nature of biochar, the WA-XRD pattern of NanoV-W5B10 is quite close to that of NanoV-W5MgO10. The size estimation from WA-XRD is in accordance with electron microscopy results.

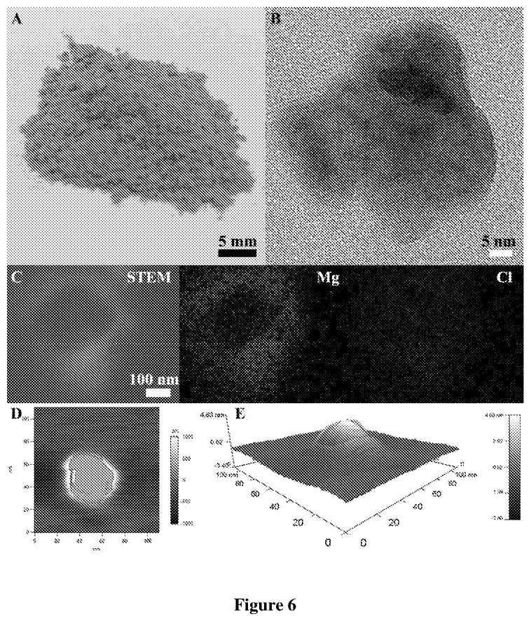

Magnesium salt is also used as another additive in the ball milling process. With the addition of 5% water and 10% MgCl₂ in the ball milling process, the product is in the form of ultra-fine powder with light brown colour (FIG. 6A). The TEM image of a typical NanoV-W5MgCl10 particle shows a thin plate-like structure with a particle size of ˜50 nm (FIG. 6B). The EDS elemental mapping of NanoV-W5MgCl10 shows the existence of both of the Mg and Cl elements (FIG. 6C), which come from the addition of MgCl₂. It is shown that the MgCl₂ crystals are finely milled to be uniformly distributed in the nanoparticles of NanoV-W5MgCl10. AFM technique is utilized to accurately measure the size and thickness of NanoV-W5MgCl10. From the top view of a typical AFM image of NanoV-W5MgCl10, the particle size is measure to be ˜50 nm (FIG. 6D), which is in accordance with the TEM result. From the side view of AFM image, the thickness of NanoV-W5MgCl10 is measured to be ˜4 nm. It is shown that with the existence of both water and MgCl₂, vermiculite can be fabricated into nanoparticle with ultra-small size and thickness in the ball milling process.

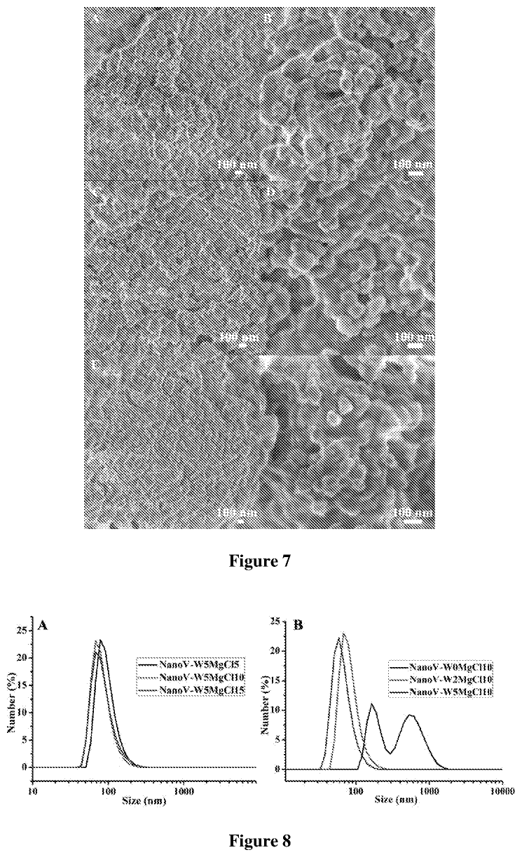

In order to investigate the key parameters to synthesize nanovermiculite with ultra-small particle size, a series of synthetic conditions are tuned, including the water amount, magnesium salt amount and the salt type. When the water amount in ball milling was kept at 5%, three nanovermiculite materials were synthesized with the MgCl₂ amount of 5, 10, and 15%, respectively. The FE-SEM images of NanoV-W5MgCl5, NanoV-W5MgCl10 and NanoV-W5Cl15 all show very small particles with the size of <100 nm (FIG. 7). No large chunks are observed in the low magnification FE-SEM. DLS technique is utilized to monitor the hydrodynamic size of nanovermiculite in aqueous solutions (FIG. 8). When the MgCl₂ amount in ball milling is 5%, the hydrodynamic size of NanoV-W5MgCl5 is 79 nm (Figure. The hydrodynamic size of NanoV-W5MgCl10 is 68 nm, which is slightly larger than the TEM measurement. This indicates the size of the nanovermiculite is influenced by the amount of magnesium salt. However, further increasing the MgCl₂ amount to 15% won't decrease the size of nanovermiculite significantly. NanoV-W5MgCl15 shows a hydrodynamic size of 67 nm.

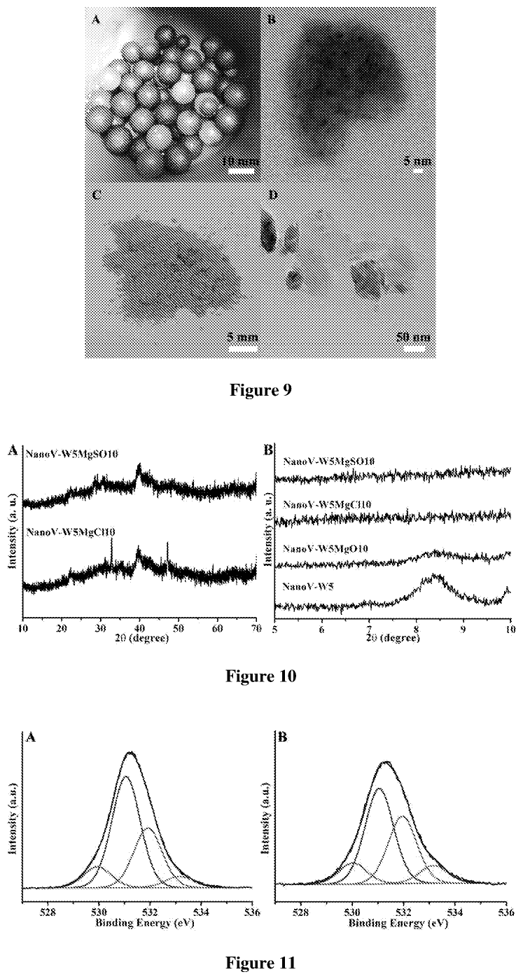

The influence from water amount to the size of nanovermiculite was also evaluated (FIG. 8B). When the MgCl₂ amount in ball milling was kept at 10%, three nanovermiculite materials were synthesized with the water amount of 0, 5, and 10%, respectively. NanoV-W0MgCl10 shows a very broad size distribution in the range of 0.1-2 μm, indicating the water amount is a very important parameter for size reduction of nanovermiculite to <100 nm. By increasing the water amount to 5-10%, the hydrodynamic size of NanoV-W5MgCl10 and NanoV-W10MgCl10 can further reduce to 58 nm. However, further increasing the water amount to 15% or more will form pasty or even liquid product, which is very hard to separate or need additional steps to remove the excess water (FIG. 9A). As a result, a semi-wet ball milling process with addition of 5-10% water is proper for synthesis powdered nanovermiculite product with easy collection and ultra-small particle size.

By changing 10% of MgCl2 to 10% of MgSO₄ in the semi-wet ball milling process, the size of NanoV-W5MgSO10 is observed to be ˜70 nm in the TEM image (FIG. 9B). The semi-ball milling process can be applied to other types of clay. With the addition of 5% of water and 10% of MgCl₂, bentonite can be milled into ultra-fine powder with grey colour (FIG. 9C). The TEM image of NanoB-W5MgCl10 show very thin thickness and the particle size in the range of 20-150 nm (FIG. 9D).

The crystalline structure of the nanovermiculite with ultra-small size is characterized by XRD (FIG. 10). The WA-XRD patterns of NanoV-W5MgCl10 and NanoV-W5MgSO10 show only a very broadened characteristic peak at 39°, which indicate the crystal size of both nanovermiculite materials are very small (FIG. 10A). These phenomena are in accordance with the TEM and DLS results. SA-XRD of a series of nanovermiculite materials were also conducted to observe the layered structure of vermiculite (FIG. 10B). The SA-XRD pattern of NanoV-W5 shows a characteristic peak at 8.4°, which can be attributed to the (002) plane of vermiculite. The d spacing is calculated to be 1.224 nm, which indicate the spacing of the layers composed of Si-tetrahedrons and Al-octahedrons. The SA-XRD pattern of NanoV-W5Mgo10 shows a broadened peak with lower intensity, indicating the nanoparticles posses a reduced number of layers. The characteristic peak at 8.4° cannot be observed in both of the SA-XRD patterns of NanoV-W5MgCl10 and NanoV-W5MgSO10, indicating a very limited layers of (002) plane. Considering the thickness of NanoV-W5MgCl10 is ˜4 nm, the layers of vermiculite is peeled to only 3-4 planes during the semi-wet milling process. The small size and thickness indicate that more edges and inner layers of the vermiculite can be exposed during the synthesis, providing more potential reaction site for cation exchange or active adsorption. The XPS technique was also utilized to test the O—Si and O—Al bonding of the nanovermiculite. FIG. 11A show the characteristic peak of O is of raw vermiculite, which is contains to proportions at 530.9 and 532.0 eV. These two proportions are 55 and 29%, which indicate the amount of oxygen atom in the form of O-MO, and HO-M (M=Si or Al), respectively. After been milled into nanoparticles, NanoV-W5MgCl10 shows the same proportions but with the amount of each proportion of 47 and 33%, respectively. This indicate the O-MO framework has been fractured during the semi-wet ball milling process.

The particle size of all nanovermiculite samples and their corresponding CEC values are summarized in Table 2. The CEC values of raw vermiculite, pre-milled vermiculite and NanoV-W5 are 1337, 1638, 1874 meq/kg. In these samples, the CEC value of vermiculite increases with the decreasing of the particle size. The addition of additives of Fe₂O₃ and MgO provide exchangeable cations. Biochar, a by-product of biomass pyrolysis, has been suggested as a promising candidate as an N fertilizer amendment and soil nutrient retention agents with very cheap price. An elemental analysis shows that there are abundant metal ions (Nat, K⁺, Ca²⁺, Mg²⁺, Al³⁺, Fe²⁺, Mn²⁺, etc.) contained in the corn biochar, which is in accordance with the literature report.^{[6]} The NanoV-W5FeO10 shows CEC value of 2062 meq/kg. After the exchange process, the supernatant contains 0.42 mg/L of Fe²⁺ which is slightly higher than the other samples. As the size of Fe₂O₃ is still >1 μm and the iron is in insoluble Fe³⁺ state, the enhancement of the total CEC is limited. The enhanced CEC mainly comes from the small size. The CEC value of NanoV-W5MgO10 is 3407 meq/kg. From the analysis of the supernatant, it can be observed that a significantly high amount of Mg²⁺ of 72.32 mg/L has been exchanged. The CEC value is significantly enhanced due to the existence of abundant exchangeable Mg²⁺ ions with the addition of MgO. The wet milling process further decrease the MgO size to the sub-micron range with is beneficial for cation exchange. Another high CEC result of 2671 meq/kg is obtained from the NanoV-W5B10. Biochar contains 2.69, 3.03 and 3.24% of Al³⁺, K⁺, Na⁺ in weight, respectively, which is in accordance with the literature report. These metal ions provide good source of exchangeable cations in the final product. It is revealed that small size and adding exchangeable ions are two important parameters for high CEC values. As the vermiculite particles are milled smaller and thinner, more cations becomes exchangeable due to the exposure of the crystal edges and basal. As a result, NanoV-W5MgCl10 and NanoV-W5MgSO10 show ultra-high CEC values of 3567 and 3533 meq/kg, respectively, which is the highest of vermiculite materials in the literature reports.

TABLE 2
Calculated CEC of nanovermiculite material.

| Sample | Raw | Pre-milled | Nano | NanoV- | NanoV- | NanoV- | NanoV- | NanoV- |
|---|---|---|---|---|---|---|---|---|
| Name | vermiculite | vermiculite | V-W5 | W5FeO10 | W5MgO10 | W5B10 | W5MgCl10 | W5MgSO10 |
| Size | 1-5 mm | 50 μm | 0.2-1 μm | 100-500 nm | 100-500 nm | 100-500 nm | 20-50 nm | 20-50 nm |
| | | | | and 1 μm | | | | |
| CEC | 1337 | 1638 | 1874 | 2062 | 3407 | 2671 | 3567 | 3533 |

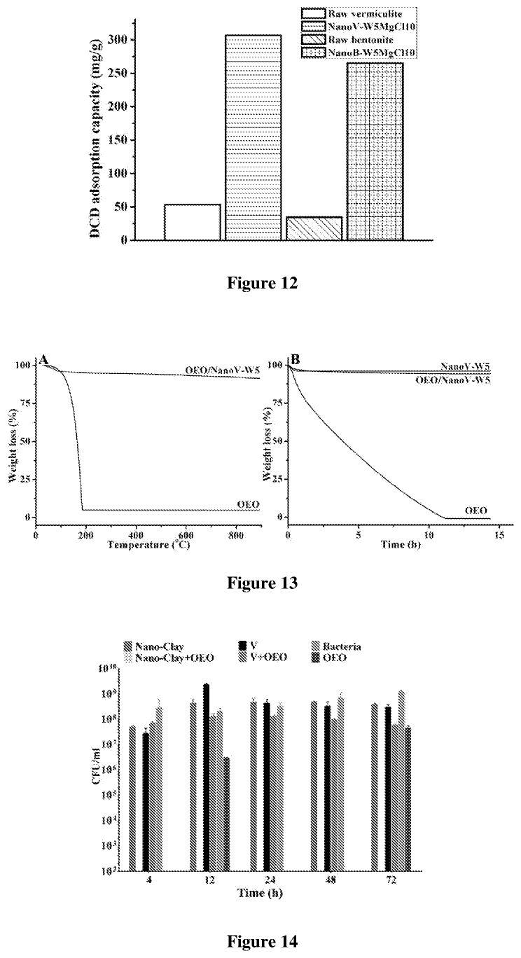

Nano-clay with ultra-small size has been used as the carrier of agriculture additives. DCD is a widely used nitrification inhibitor in agriculture. The DCD adsorption amounts of raw vermiculite, NanoV-W5MgCl10, raw bentonite and NanoB-W5MgCl10 are 53.7, 306.8, 34.7 and 265.1, respectively (FIG. 12). Due to exposed surface by decreasing the size and thickness, nano-clay show 6-7 times higher DCD adsorption capacity compared to raw clay materials. It is shown that nano-clay are potential nano-carriers for agricultural actives for various applications.

The TGA results of free OEO and OEO-nano-clay formulation are illustrated in FIG. 13. The TGA results indicate that the complete evaporative loss of OEO (free OEO, without carrier, Figure A) occurs at temperatures below 200° C. No weight loss was observed for nano-clay (NanoV-W5) under 200° C. Thus the OEO loading amount can be measured by the weight loss below 200° C., which is 4.9% by weight. The calculated loading amount is in accordance with the feeding ratio of OEO and NanoV-W5. Due to the higher surface area nano-clay, high loadings of up to 25% by weight can be achieved.

As an essential oil, the volatile property of OEO hinder it transportation and application. The ability of the nano-clay to prevent evaporation of the OEO from the formulation was examined by an isothermal release study at a constant temperature of 60° C. for a period of 14 hours. FIG. 13B shows the free OEO has 100% weight loss in 11 hours in the isothermal release study. In comparison, the OEO/NanoV-W5 has only 40% loss of OEO in 14 hours in the same condition. This data demonstrates that the nano-clay provides marginally better protection against OEO evaporation.

Long term bacterial inhibition testing of OEO-nano-clay formulation was evaluated. FIG. 14 shows the CFU assay results. The free OEO was used at its MBC and shows antibacterial performance at the earliest time point 4 h However, bacterial regrowth is seen at the 12 h and 72 h time points. It is not clear why regrowth was not seen for the 24 h and 48 h samples. For raw vermiculite formulation (V+OEO), no antibacterial effect can be seen at this oil concentration with a long period of 72 h. The OEO/NanoV-W5 formulation suppresses bacteria at the earliest time point (4 h) and no bacterial regrowth is seen over the 72 h period. The nano-clay itself did not show an antibacterial effect, indicating the enhancement of the long-term bacterial inhibition comes from the delivery of OEO by nanocarrier.

In the present specification and claims (if any), the word ‘comprising’ and its derivatives including ‘comprises’ and ‘comprise’ include each of the stated integers but does not exclude the inclusion of one or more further integers.

Reference throughout this specification to ‘one embodiment’ or ‘an embodiment’ means that a particular feature, structure, or characteristic described in connection with the embodiment is included in at least one embodiment of the present invention. Thus, the appearance of the phrases ‘in one embodiment’ or ‘in an embodiment’ in various places throughout this specification are not necessarily all referring to the same embodiment. Furthermore, the particular features, structures, or characteristics may be combined in any suitable manner in one or more combinations.

In compliance with the statute, the invention has been described in language more or less specific to structural or methodical features. It is to be understood that the invention is not limited to specific features shown or described since the means herein described comprises preferred forms of putting the invention into effect. The invention is, therefore, claimed in any of its forms or modifications within the proper scope of the appended claims (if any) appropriately interpreted by those skilled in the art.

1. A method for producing nano-clays, the method comprising forming a mixture of a clay and water, wherein water is present in an amount of from 2 to 10% by weight of the total weight of clay and water, and milling the mixture of clay and water in the presence of a grinding media to form the nano-clay.

2. A method as claimed in claim 1 wherein the mixture of clay and water comprises from 5% to 10% water, calculated as a weight percentage of the weight of water of the total weight of the clay and water, or the mixture of clay and water comprises from 6% to 10% water, or from 7% to 10% water, from 8% to 10% water, or from 9% to 10% water, all calculated as a percentage of the weight of water of the total weight of the clay and water.

3. A method as claimed in claim 1, or from 10 minutes to 4 hours, or from 30 minutes to 2 hours, or for a period of up to 2 hours.

4. A method as claimed in claim 1 wherein further material including metal ions that assist in exfoliating the clay layers and/or breaking Si—O/Al—O framework of the clay to break the clay particles into thin and small particles is present in the milling step.

5. A method as claimed in claim 4 wherein the further material is selected from a salt, a metal oxide, biochar, or mixtures of two or more thereof.

6. A method as claimed in claim 4 wherein the further material is in particulate form.

7. A method as claimed in claim 4 wherein the further material is added in an amount of from 5% to 15%, by weight, calculated as a weight percentage of the weight of water and clay.

8. A method as claimed in claim 4 wherein the further material comprises a salt selected from magnesium chloride, magnesium sulphate, magnesium nitrate, sodium chloride, sodium sulphate, sodium nitrate, potassium chloride, potassium sulphate, potassium nitrate, calcium chloride, calcium sulphate, calcium nitrate, iron chloride, iron sulphate, iron nitrate, zinc chloride, zinc sulphate and zinc nitrate or mixtures of two or more thereof.

9. A method as claimed in claim 4 wherein the further material comprises a metal oxide selected from magnesium oxide, iron oxide, magnetite, calcium oxide, or mixtures of two or more thereof.

10. (canceled)

11. A method as claimed claim 1 wherein the clay comprises vermiculite, bentonite, beidellite, ripidolite, Na⁺-montmorillonite, organo-montmorillonite clays, kaolin or kaolinite, or mixtures of two or more thereof.

12. A method as claimed in claim 11 wherein the clay comprises expanded vermiculite.

13. A method as claimed claim 1 wherein the clay that is supplied to the milling step is pre-treated.

14. A method as claimed in claim 13 wherein the pre-treatment comprises contacting the clay with a dilute acid, followed by washing with water and optionally drying the clay following washing.

15. A method as claimed claim 1 further comprising the step of separating milled material from the grinding media.

16. A method as claimed claim 1 further comprising the step of separating ground material from the grinding media and mixing the nano-clay with one or more agents such that the one or more agents are taken up by the nano clay.

17. A method as claimed claim 1 wherein a product clay material obtained by the method has a narrow particle size distribution.

18. A method as claimed in claim 4 wherein nano-clay particles formed in the milling step have a thickness of about 4 nm.

19. A method as claimed claim 1 wherein the grinding media comprises grinding balls or grinding rods.

20. A method for producing nano-clays, the method comprising forming a mixture of a clay and water, wherein water is present in an amount of from 2 to 10% by weight of the total weight of clay and water, and milling the mixture of clay and water in the presence of further material including metal ions that assist in exfoliating the clay layers and/or breaking Si—O/Al—O framework of the clay to break the clay particles into thin and small particles to form the nano-clay.

21. A method as claimed in claim 20 wherein the further material is selected from a salt, a metal oxide, biochar, or mixtures of two or more thereof.
